(19) United States
(12) Patent Application Publication
(10) Pub. No.: US 2009/0080308 A1
(43) Pub. Date: Mar. 26, 2009

(54) RECORDING APPARATUS, REPRODUCTION APPARATUS, RECORDING AND REPRODUCTION APPARATUS, RECORDING METHOD, AND REPRODUCTION METHOD

(75) Inventor: Ryuji Yano, Tokyo (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: SONY CORPORATION, Tokyo (JP)

(21) Appl. No.: 12/211,269

(22) Filed: Sep. 16, 2008

(30) Foreign Application Priority Data
Sep. 20, 2007 (JP) 2007-244364

(51) Int. Cl. G11B 27/00

(52) U.S. Cl. 369/83; G9B/27

(57) ABSTRACT

A recording apparatus for recording information on a recording medium on which rewrite can be performed by using an optical element, the recording apparatus including: an information recording unit adapted to record overwrite inhibit information indicating that overwrite on the recording medium is inhibited, in a predetermined zone before start of recording on the recording medium; and a recording determination unit adapted to determine whether or not the recording on the recording medium is succeeded, in which the information recording unit performs the recording by filling the predetermined zone with overwrite permit information indicating that overwrite on the recording medium is permitted in a case where the recording determination unit determines that the recording on the recording medium is succeeded.

### CROSS REFERENCES TO RELATED APPLICATIONS

The present invention contains subject matter related to Japanese Patent Application JP 2007-244364 filed in the Japanese Patent Office on Sep. 20, 2007, the entire contents of which are incorporated herein by reference.

### BACKGROUND OF THE INVENTION

1. Field of the Invention

The present invention relates to a recording apparatus, a reproduction apparatus, a recording and reproduction apparatus, a recording method, and a reproduction method. The invention more specifically relates to a recording apparatus, a reproduction apparatus, a recording and reproduction apparatus, a recording method, and a reproduction method for a recording medium on which rewrite can be performed by using an optical element.

2. Description of the Related Art

In a recording medium like an optical disc on which rewrite of data can be performed by using an optical element such as a laser light, when write or overwrite of data is performed in a recording apparatus such as a disc recorder, physical management information which is recorded in a predetermined zone of the recording medium is updated. The physical management information holds recording end position information, recording state information, and the like. When the recording medium is inserted into the recording apparatus next time, the write or overwrite of the data is performed on the basis of this physical management information.

However, at the time of the update of the physical management information, in a case where the update of the physical management information is failed due to an accidental failure, for example, a stop of the disc recorder caused by an interruption of power supply or the like, previously recorded data may be damaged in some cases when the recording medium is inserted into the recording apparatus next time.

As a technology for solving such a problem, Japanese Unexamined Patent Application Publication Nos. 2005-38570 and 2005-285159 propose the following technologies. According to Japanese Unexamined Patent Application Publication No. 2005-38570, the physical management information is updated each time the recording of data at a certain length on the disc is ended. Then, according to Japanese Unexamined Patent Application Publication No. 2005-285159, in a case where the writing on the disc falls into inhibited condition due to an accidental failure before the disc is ejected, a recovery is conducted to a state in which the recording on the disc can be preformed by starting over a tracking servo and a focus servo through rotating a spindle of the disc recorder again.

### SUMMARY OF THE INVENTION

However, according to the method described in Japanese Unexamined Patent Application Publication No. 2005-38570, the recording processing causes a large burden in the disc recorder such as a video camera in which a real-time performance is highly demanded, and it is difficult to perform the recording in a real-time manner. Also, according to the method described in Japanese Unexamined Patent Application Publication No. 2005-285159, the recording may be failed even after the servo is started over in some cases, and there is a problem that the disc is not ejected for a long period of time by continuing the conduct of the servo reactivation.

The present invention has been made in view of the above-mentioned problems, and it is desirable to provide a recording apparatus, a reproduction apparatus, a recording and reproduction apparatus, a recording method, and a reproduction method which are novel and revised in which normal update of physical information can be determined by updating a predetermined zone of a recording medium before recording start of the physical information and after recording end of the physical information.

In order to solve the above-mentioned problems, according to an embodiment of the present invention, there is provided a recording apparatus for recording information on a recording medium on which rewrite is permitted by using an optical element, the recording apparatus including: an information recording unit adapted to record overwrite inhibit information indicating that overwrite on the recording medium is inhibited, in a predetermined zone before start of recording on the recording medium; and a recording determination unit adapted to determine whether or not the recording on the recording medium is succeeded, in which the information recording unit performs recording by filling the predetermined zone with overwrite permit information indicating that overwrite on the recording medium is permitted in a case where the recording determination unit determines that the recording on the recording medium is succeeded.

According to the above-mentioned configuration, before the start of recording on the recording medium, the information recording unit records the overwrite inhibit information indicating that overwrite on the recording medium is inhibited in the predetermined zone, and the recording determination unit determines whether or not the recording on the recording medium is succeeded. Then, in a case where the recording determination unit determines that the recording on the recording medium is succeeded, the information recording unit performs the recording by filling the predetermined zone with the overwrite permit information indicating that overwrite on the recording medium is permitted. As a result, by updating the predetermined zone of the recording medium before the recording start of the physical management information and after the recording end, it is possible to distinguish the normal update of the physical management information.

The predetermined zone may be an IDRT (Inner Drive Test Zone) zone, and the overwrite inhibit information and the overwrite permit information may be recorded in an OPC (Optimum Power Calibration) execution area in the IDRT zone. As a result, before the update of the physical management information, the overwrite inhibit information is written in the OPC execution area in the IDRT zone, and after the update of the physical management information, the overwrite permit information is written in the OPC execution area in the IDRT zone, so that it is possible to determine whether or not the physical management information is normally updated on the recording medium.

The overwrite inhibit information may be a value other than 0, and the overwrite permit information may be 0. According to the above-mentioned configuration, before the start of recording on the recording medium, the information recording unit records the value other than 0 in the predetermined zone for the recording medium, and in a case where the recording determination unit determines that the recording on the recording medium is succeeded, the information recording unit records so as to fill the predetermined zone with 0. As a result, depending on whether or not the predetermined zone is recorded so as to be filled with 0, it is possible to determine whether or not the physical management information is normally updated on the recording medium.

The recording medium is one of DVD+RW and Blu-ray disc. By writing one of the overwrite inhibit information and the overwrite permit information in the predetermined zone of DVD+RW or Blu-ray disc, it is possible to determine whether or not the physical management information is normally updated on the medium.

In addition, in order to solve the above-mentioned problems, according to another embodiment of the present invention, there is provided a reproduction apparatus for reproducing by using an optical element, information recorded on a recording medium on which overwrite is permitted by using an optical element and in which information for determining whether or not rewrite is permitted is recorded in a predetermined zone, the reproduction apparatus including: a reproduction unit adapted to reproduce the information recorded on the recording medium, in which the reproduction unit reads the information recorded in the predetermined zone of the recording medium to determine whether or not overwrite on the recording medium is permitted.

According to the above-mentioned configuration, the reproduction unit reproduces the information recorded on the recording medium, and the reproduction unit reads the information recorded in the predetermined zone of the recording medium to determine whether or not the overwrite on the recording medium is permitted. As a result, by reading the information recorded in the predetermined zone of the recording medium, it is possible to determine whether or not the relevant recording medium is the recording medium on which the physical management information is normally updated.

The reproduction unit may determine that overwrite on the recording medium is permitted when 0 is recorded in the predetermined zone, and may determine that overwrite on the recording medium is inhibited when a value other than 0 is recorded in the predetermined zone.

The recording medium may be one of DVD+RW and Blu-ray disc. By writing one of the overwrite inhibit information and the overwrite permit information in the predetermined zone of DVD+RW or Blu-ray disc, it is possible to determine whether or not the physical management information is normally updated on the medium.

In addition, in order to solve the above-mentioned problems, according to another embodiment of the present invention, there is provided a recording and reproduction apparatus for recording information on a recording medium on which rewrite is permitted by using an optical element and reproducing the recorded information by using an optical element, the recording and reproduction apparatus including: an information recording unit adapted to record overwrite inhibit information indicating that overwrite on the recording medium is inhibited, in a predetermined zone before start of recording on the recording medium; and a recording determination unit adapted to determine whether or not the recording on the recording medium is succeeded; and a reproduction unit adapted to reproduce the information recorded on the recording medium, in which the information recording unit records so as to fill the predetermined zone with overwrite permit information indicating that overwrite on the recording medium is permitted in a case where the recording determination unit determines that the recording on the recording medium is succeeded, and the reproduction unit reads the predetermined zone to determine whether or not overwrite on the recording medium is permitted.

According to the above-mentioned configuration, before the start of recording on the recording medium, the information recording unit records the overwrite inhibit information indicating that overwrite on the recording medium is inhibited in the predetermined zone, and the recording determination unit determines whether or not the recording on the recording medium is succeeded. Then, the information recording unit performs the recording by filling the predetermined zone with overwrite permit information indicating that overwrite on the recording medium is permitted in a case where the recording determination unit determines that the recording on the recording medium is succeeded. Also, the reproduction unit reads the predetermined zone to determine whether or not the overwrite on the recording medium is permitted. As a result, by updating the predetermined zone of the recording medium before the recording start of the physical management information and after the recording end, it is possible to distinguish the normal update of the physical management information of the recording medium, and also, by reading the information recorded in the predetermined zone of the recording medium, it is possible to determine whether or not the relevant recording medium is the recording medium on which the physical management information is normally updated.

The reproduction unit may determine that overwrite on the recording medium is permitted when 0 is recorded in the predetermined zone, and may determine that overwrite on the recording medium is inhibited when a value other than 0 is recorded in the predetermined zone.

The predetermined zone may be an IDRT (Inner Drive Test Zone) zone, and the overwrite inhibit information and the overwrite permit information may be recorded in an OPC (Optimum Power Calibration) execution area in the IDRT zone. As a result, by writing the overwrite inhibit information in the OPC execution area in the IDRT zone before the update of the physical management information and writing the overwrite permit information in the OPC execution area in the IDRT zone after the update of the physical management information, it is possible to determine whether or not the physical management information is normally updated on the recording medium.

The overwrite inhibit information may be a value other than 0, and the overwrite permit information may be 0. According to the above-mentioned configuration, before the recording start on the recording medium, the information recording unit records the value other than 0 in the predetermined zone with respect to the recording medium, and in a case where the recording determination unit determines that the recording on the recording medium is succeeded, the predetermined zone is recorded so as to be filled with 0. As a result, depending on whether or not the predetermined zone is recorded so as to be filled with 0, it is possible to determine whether or not the physical management information is normally updated on the recording medium.

The recording medium may be one of DVD+RW and Blu-ray disc. By writing one of the overwrite inhibit information and the overwrite permit information in the predetermined zone of DVD+RW or Blu-ray disc, it is possible to determine whether or not the physical management information is normally updated on the medium.

In addition, in order to solve the above-mentioned problems, according to another embodiment of the present invention, there is provided a recording method for recording information on a recording medium on which rewrite can be performed by using an optical element, the recording method including the steps of: recording overwrite inhibit information indicating that overwrite on the recording medium is inhibited, in a predetermined zone before start of recording on the recording medium; determining whether or not the recording on the recording medium is succeeded; and recording so as to fill the predetermined zone with overwrite permit information indicating that overwrite on the recording medium is permitted in a case where it is determined that the recording on the recording medium is succeeded.

According to the above-mentioned configuration, the recording step includes recording the overwrite inhibit information indicating that overwrite on the recording medium is inhibited, in the predetermined zone before the start of recording on the recording medium, the determining step includes determining whether or not the recording on the recording medium is succeeded, and the recording step includes recording so as to fill the predetermined zone with the overwrite permit information indicating that overwrite on the recording medium is permitted in a case where it is determined in the determining step that the recording on the recording medium is succeeded. As a result, by updating the predetermined zone of the recording medium before the recording start of the physical management information and after the recording end, it is possible to distinguish the normal update of the physical management information on the recording medium.

In addition, in order to solve the above-mentioned problems, according to another embodiment of the present invention, there is provided a reproduction method for reproducing by using an optical element, information recorded on a recording medium on which overwrite is permitted by using an optical element and in which information for determining whether or not rewrite is permitted is recorded in a predetermined zone, the reproduction method including the step of: reproducing the information recorded on the recording medium, in which the reproducing step includes reading the information recorded in the predetermined zone of the recording medium to determine whether or not overwrite on the recording medium is permitted.

According to the above-mentioned configuration, the reproducing step includes reproducing the information recorded on the recording medium. Also, the reproducing step includes reading the information recorded in the predetermined zone of the recording medium to determine whether or not the overwrite on the recording medium is permitted. As a result, by reading the information recorded in the predetermined zone of the recording medium, it is possible to determine whether or not the relevant recording medium is the recording medium on which the physical management information is normally updated.

As described above, according to the embodiment of the present invention, it is possible to provide the recording apparatus, the reproduction apparatus, the recording and reproduction apparatus, the recording method, and the reproduction method which are novel and revised in which the normal update of the physical information can be determined by updating the predetermined zone of the recording medium before the recording start of the physical information and after the recording end of the physical information.

### BRIEF DESCRIPTION OF THE DRAWINGS

FIG. 1 is an explanatory diagram for describing a configuration of a disc camcorder according to an embodiment of the present invention;

FIGS. 2A and 2B are flowcharts for describing an operation of the disc camcorder in a case where an optical disc is inserted into the disc camcorder;

FIG. 3 is a flowchart for describing a PFI information obtaining processing when using the disc camcorder according to an embodiment of the present invention;

FIG. 4 is an explanatory diagram for describing a management data configuration of DVD+RW;

FIG. 5 is a flowchart for describing a recording method for an optical disc according to an embodiment of the present invention; and

FIG. 6 is a flowchart for describing a reproduction method for the optical disc on which recording is performed through the recording method according to the embodiment of the present invention.

### DESCRIPTION OF THE PREFERRED EMBODIMENTS

Hereinafter, with reference to the accompanying drawings, preferred embodiments of the present invention will be described in detail. It should be noted that in the present specification and drawings, components which have substantially identical functions and configurations are denoted by the same reference numerals, and repetitive descriptions will be omitted.

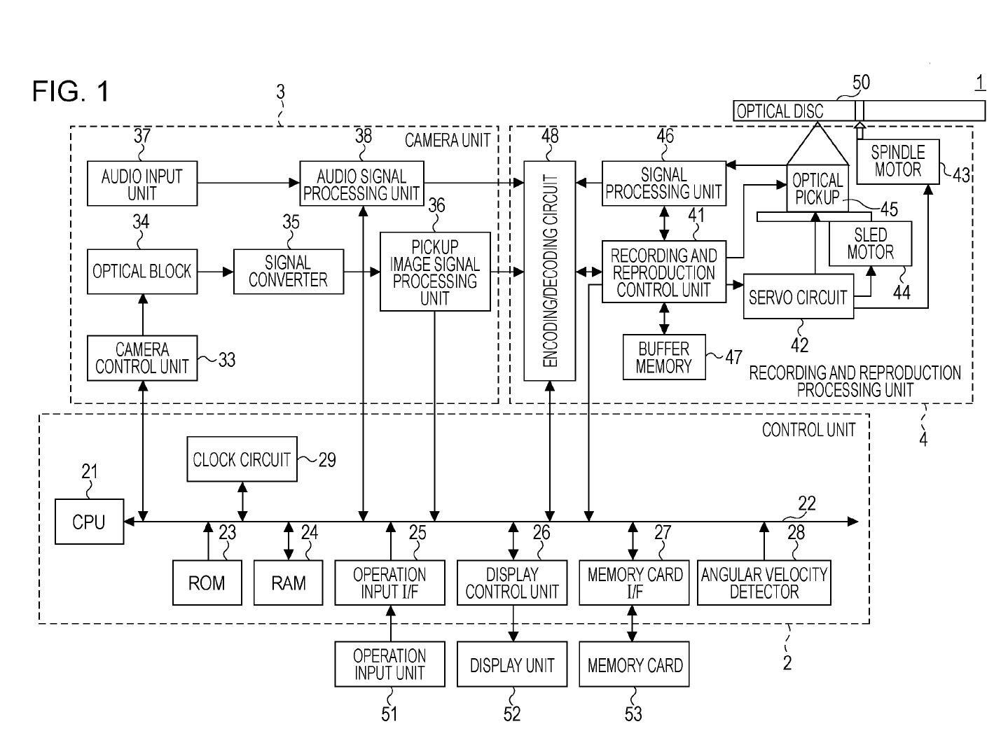

First, a disc camcorder 1 according to an embodiment of the present invention will be described. FIG. 1 is an explanatory diagram for describing a configuration of the disc camcorder 1 according to the embodiment of the present invention. Hereinafter, by using FIG. 1, the configuration of the disc camcorder 1 will be described.

The disc camcorder 1 is adapted to record information on an optical disc which is an example of a recording medium of the present invention. In particular, the disc camcorder 1 is adapted to record motion pictures on the optical disc in real time. As illustrated in FIG. 1, the disc camcorder 1 according to the embodiment of the present invention is composed by including a control unit 2, a camera unit 3, and a recording and reproduction processing unit 4.

The control unit 2 is adapted to control a recording operation and a reproduction operation of the disc camcorder 1. The control unit 2 is composed by including a CPU (Central Processing Unit) 21, a ROM 23, a RAM 24, an operation input I/F 25, a display control unit 26, a memory card I/F 27, an angular velocity detector 28, and a clock circuit 29. The respective units of the control unit 2 and the respective units of the camera unit 3 and the recording and reproduction processing unit 4 are mutually connected via a bus 22.

The CPU 21 controls the respective units of the control unit 2 and also control the camera unit 3 and the recording and reproduction processing unit 4 connected via the bus 22 by way of a predetermined control signal, thus controlling the entire disc camcorder 1 in an overall manner. The CPU 21 is adapted to execute various processings and a recording preparation processing at the time of optical disc insertion which will be described below on the basis of various basic programs, activation programs, and the like, which are previously stored in the ROM 23 or the RAM 24.

The operation input I/F 25 is connected to an operation input unit 51 and transmits an operation input performed by a user from the operation input unit 51. The display control unit 26 is connected to a display unit 52 and controls a display operation on the display unit 52. The memory card I/F 27 is connected to a memory card 53 and controls recording and reproduction operations on the memory card 53.

The CPU 21 sends a control signal in accordance with the operation on the operation input unit 51 performed by the user in a state where an optical disc 50 is inserted into a disc insertion part of the disc camcorder 1 which is not shown in FIG. 1. For example, when an operation input signal such an instructing for a start of an image pickup processing, a reproduction processing, or the like from the user who uses the disc camcorder 1 is supplied via the operation input I/F 25, the CPU 21 generates a control signal in accordance with the operation input signal to be sent to the respective units of the control unit 2, the camera unit 3, the recording and reproduction processing unit 4.

The angular velocity detector 28 is adapted to generate angular velocity information which indicates an angular velocity applied from the outside on the disc camcorder 1. As the angular velocity detector 28, for example, a gyroscope may be used. As the disc camcorder 1 is provided with the angular velocity detector 28, it is possible to stabilize the disc camcorder 1 and compensate camera-shake caused by the user. The clock circuit 29 is adapted to generate time information which indicates year, month, and day, hour, minute, and seconds, etc.

The camera unit 3 is adapted to pick up an image of a subject and convert the information obtained through the image pickup into an electric signal. The camera unit 3 is composed by including a camera control unit 33, an optical block 34, a signal converter 35, a pickup image signal processing unit 36, an audio input unit 37, and an audio signal processing unit 38.

The camera control unit 33 is adapted to control an operation of the optical block 34. The optical block 34 has therein, although not shown in FIG. 1, a lens group for picking an image of the subject, an iris adjustment mechanism, a focus adjustment mechanism, a zoom mechanism, a shutter mechanism, a flash mechanism, a camera-shake correction mechanism, and the like.

The signal converter 35 is adapted to convert the subject light for image pickup obtained by the optical block 34 into an electric signal. As the signal converter 35, an image sensor such as a CCD (Charge Coupled device) or a CMOS (Complementary Metal Oxide Semiconductor) may be used.

The pickup image signal processing unit 36 is adapted to generate a picked-up image signal by performing a gamma correction processing, an AGC (Auto Gain Control) processing, and an analog digital processing on the electric signal (image pickup signal) supplied from signal converter 35.

The audio input unit 37 is adapted to gather sound around the disc camcorder 1 to generate an audio signal when the image pickup operation is performed by the disc camcorder 1 and supply the audio signal to the audio signal processing unit 38. The audio signal processing unit 38 is adapted to generate a digital audio signal by performing various correction processings, the AGC processing, and the analog digital processing on the audio signal on the basis of the control signal from the control unit 2.

The recording and reproduction processing unit 4 is adapted to perform recording and reproduction processings on data for the optical disc 50 to be inserted into the disc camcorder 1. The recording and reproduction processing unit 4 is composed by including a recording and reproduction control unit 41, a servo circuit 42, a spindle motor 43, a sled motor 44, an optical pickup 45, a signal processing unit 46, a buffer memory 47, and an encoding/decoding circuit 48.

The recording and reproduction control unit 41 is adapted to control the respective units of the recording and reproduction processing unit 4 by sending command signals to the respective units of the recording and reproduction processing unit 4 and execute the recording processing on the optical disc 50 and the reproduction processing on the optical disc 50. The recording and reproduction control unit 41 is adapted to send the command signals to the respective units of the recording and reproduction processing unit 4 in accordance with the control signal supplied from the CPU 21.

When the picked-up image signal or the digital audio signal is supplied from the camera unit 3, the encoding/decoding circuit 48 generates an EFM+ (Eight to Fourteen Modulation Plus) signal by encoding the picked-up image signal and the digital audio signal. The thus generated EFM+ signal is sent to the recording and reproduction control unit 41. While the EFM+ signal sent from the encoding/decoding circuit 48 is temporarily stored in the buffer memory 47, the recording and reproduction control unit 41 controls the optical pickup 45 to execute the recording processing on the optical disc 50.

The servo circuit 42 is adapted to rotate the spindle motor 43 and the sled motor 44 in accordance with the command signals sent from the recording and reproduction control unit 41. The spindle motor 43 is adapted rotate a turn table (not shown) to rotate and drive the optical disc 50 placed on the turn table. The sled motor 44 is adapted to operate an actuator (not shown) and move the optical pickup 45 by way of rotation of the sled motor 44.

The optical pickup 45 is an example of an information recording unit of the present invention. The optical pickup 45 is adapted to irradiate a recording layer of the optical disc 50 with a laser light and also photoelectrically convert the reflection laser light reflected by the recording layer of the optical disc 50 to generate a photoelectric signal in accordance with the reflection light amount. The photoelectric signal generated by the optical pickup 45 is sent to the signal processing unit 46.

The signal processing unit 46 is adapted to generate a tracking error signal and a focus error signal for controlling the optical pickup 45 in accordance with the photoelectric signal supplied from the optical pickup 45. The tracking error signal and the focus error signal thus generated are sent to the recording and reproduction control unit 41.

The buffer memory 47 is adapted to temporarily store the EFM+ signal sent from the encoding/decoding circuit 48. The recording and reproduction control unit 41 reads out the EFM+ signal stored in the buffer memory 47 to control the optical pickup 45.

The recording and reproduction control unit 41 controls the optical pickup 45 via the servo circuit 42 to drive the sled motor 44 in accordance with the tracking error signal and move the optical pickup 45 in a tracking direction. In addition to the above, the recording and reproduction control unit 41 drives an object glass driver device (not shown) of the optical pickup 45 in the tracking direction, a focus direction, and a tilt direction to move an object glass to an optimal position in accordance with the tracking error signal and the focus error signal.

In a case where the information recorded on the optical disc 50 is reproduced, the recording layer of the optical disc 50 is irradiated with the laser light from the optical pickup 45 which also functions as an example of the reproduction unit according to the embodiment of the present invention, and the reflection laser light reflected by the recording layer is photoelectrically converted. Then, on the basis of the photoelectric signal in accordance with the reflection light amount, a reproduction signal is generated in the signal processing unit 46. The reproduction signal generated in the signal processing unit 46 is sent to the encoding/decoding circuit 48, and the encoding/decoding circuit 48 decodes the reproduction signal into an image signal (reproduction image signal). The reproduction image signal decoded in this manner is sent to the CPU 21.

When the picked-up image signal and the reproduction image signal are respectively supplied from the camera unit 3 and the recording and reproduction processing unit 4, the CPU 21 displays a picked-up image and a reproduction image on the basis of the picked-up image signal and the reproduction image signal on the display unit 52 via the display control unit 26.

Also, the CPU 21 records via the memory card I/F 27, image pickup data (data including the picked-up image signal and the digital audio signal) supplied from the recording and reproduction processing unit 4 on the memory card 53, and on the other hand reproduces the image pickup data recorded on the memory card 53 via the memory card I/F 27 to be supplied to the recording and reproduction processing unit 4.

In the above, the configuration of the disc camcorder 1 according to the embodiment of the present invention has been described. Next, a recording method for the optical disc using the disc camcorder 1 according to the embodiment of the present invention will be described.

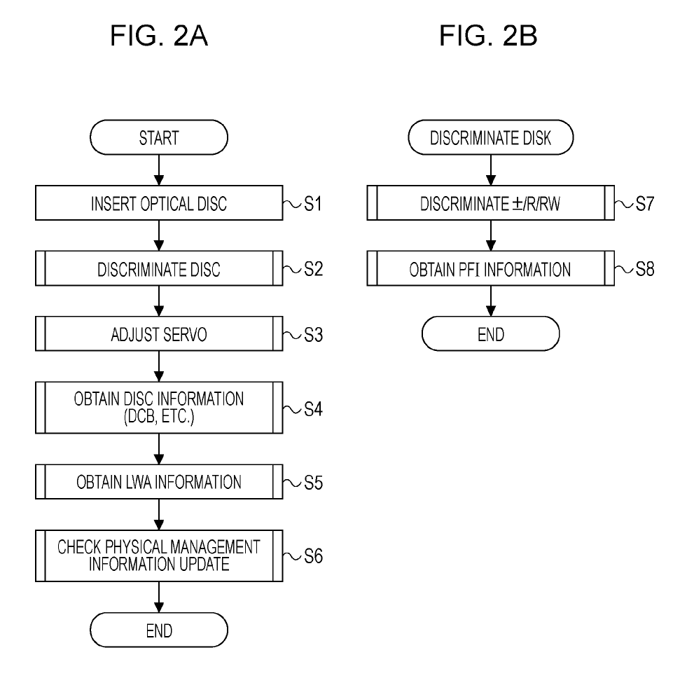

First, an operation of the disc camcorder 1 in a case where the optical disc is inserted into the disc camcorder 1 will be described. FIGS. 2A and 2B are flowcharts for describing the operation of the disc camcorder 1 in a case where the optical disc is inserted into the disc camcorder 1. FIG. 2A is a flowchart for describing a flow of the operation in a case where the optical disc is inserted into the disc camcorder 1 according to the embodiment of the present invention. Also, in the below, a description will be given of a case in which the optical disc is DVD+RW.

When the optical disc 50 is inserted into the disc camcorder 1 (step S1), the CPU 21 instructs the optical pickup 45 to perform a focus search. Then, the CPU 21 discriminates a type of the disc on the basis of the reflection light amount from the optical disc 50, the presence or absence of a Wobble signal, and identification information included in PFI (Physical Format Information) information which is recorded on the medium, which are obtained through the optical pickup 45 and the signal processing unit 46 (step S2).

After the disc type is discriminated, the servo circuit 42 is controlled to perform the servo adjustment for each disc such as an inclination of the disc, offsets of the focus servo and the tracking servo, and the gain (step S3). After the servo adjustment is performed, the focus servo and the tracking servo are turned ON to read disc information such as DCB (Disc Control Blocks) information from a disc management information zone (step S4).

Subsequently, by utilizing the physical management information such as the thus obtained PFI information or DCB information, LWA (Last Written Address) information is confirmed which is information on a recording end position in a user data zone in the optical disc 50 (step S5). After the LWA information is confirmed, the CPU 21 checks a test write zone (IDRT: Inner Drive Test Zone) usable for OPC (Optimum Power Calibration), and instructs the optical pickup 45 to stand by at the position (step S6).

FIG. 2B is a flowchart for describing the above-mentioned disc discrimination processing in step S2. When the disc is discriminated, the type of R/RW is discriminated on the basis of the size of the reflection light amount from the optical disc 50, and the type of +/− of DVD is discriminated on the basis of the presence or absence of the Wobble signal (step S7). Then, the PFI information recorded on the optical disc 50 is obtained, and by reading out disc identification information included in the PFI information, the determination results are confirmed (step S8).

In the above, by using FIGS. 2A and 2B, the operation in the case where the optical disc 50 is inserted into the disc camcorder 1 has been described. Subsequently, a PFI information obtaining processing in step S18 will be described.

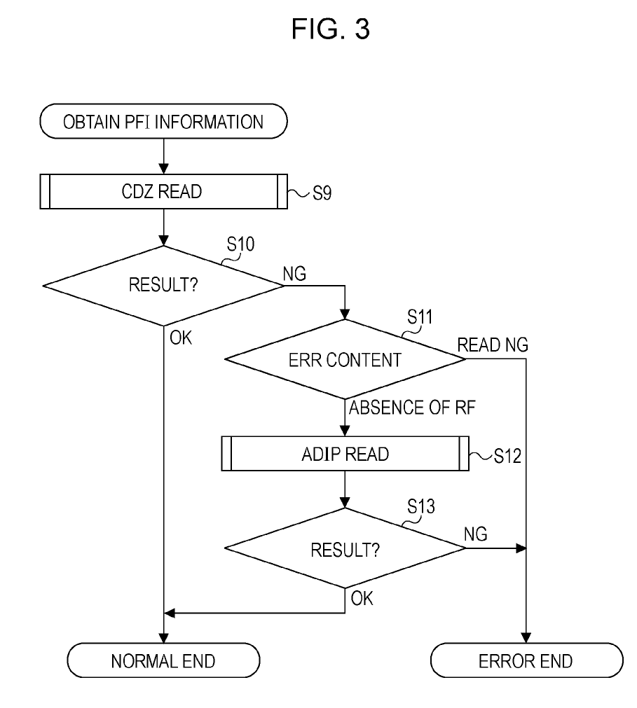

FIG. 3 is a flowchart for describing the PFI information obtaining processing using the disc camcorder 1 according to the embodiment of the present invention. Hereinafter, with reference to FIG. 3, the PFI information obtaining processing using the disc camcorder 1 according to the embodiment of the present invention will be described.

First, the read of the PFI information from CDZ (Control Data Zone) of the optical disc 50 (step S9) is conducted. In a case where the read is achieved, the PFI information obtaining processing is immediately ended (step S10). However, in a case where the read is failed, the subsequent processing is branched due to a cause of the read failure (step S11).

In a case where the cause of the read failure is the absence of RF (Radio Frequency), that is, the RF is not recorded on the optical disc 50, read is conducted from ADIP (Address In PreGroove) of the optical disc 50 (step S12). On the other hand, in a case where the read is failed due to a cause other than the absence of the RF, the PFI information obtaining processing is ended as an error. Also, in step S12 described above, in the case where the read from the ADIP is failed, the PFI information obtaining processing is ended as an error (step S13).

In the above, the PFI information obtaining processing using the disc camcorder 1 according to the embodiment of the present invention has been described. Next, a management data configuration for DVD+RW will be described.

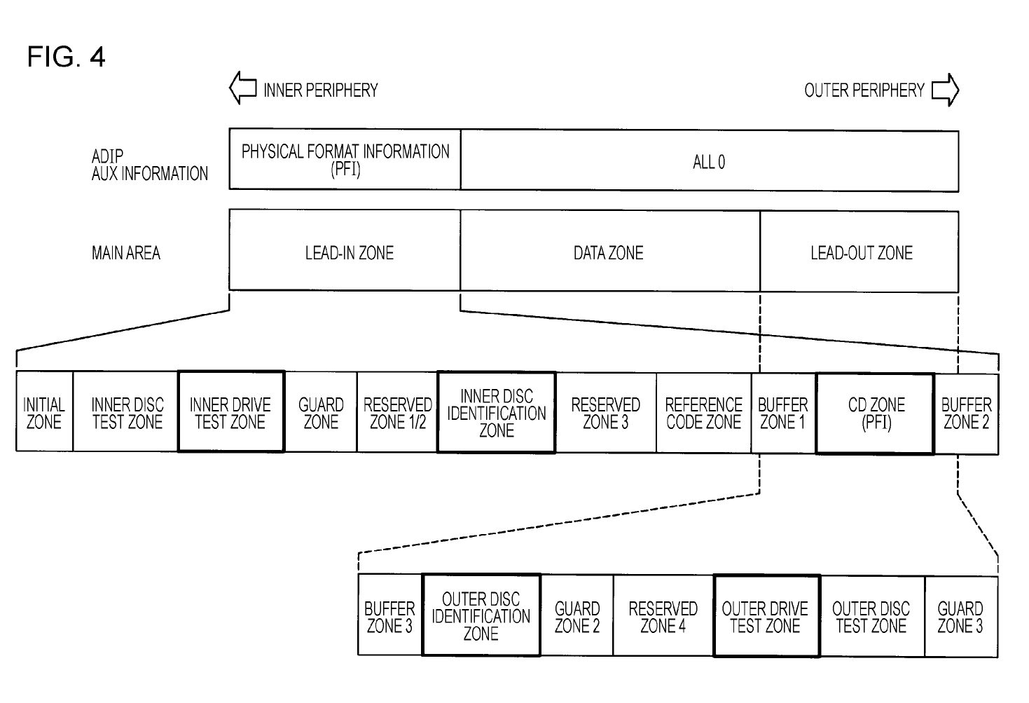

FIG. 4 is an explanatory diagram for describing a management data configuration of DVD+RW. Hereinafter, by using FIG. 4, the management data configuration of DVD+RW will be described. It should be noted that in FIG. 4, the left side of the drawing indicates the inner periphery and the right side of the drawing indicates the outer periphery.

A main area is composed of a lead-in zone, a data zone, and a lead-out zone in the stated order from the inner periphery side. In the ADIP corresponding to the Data Zone and the lead-out zone, the PFI information is not recorded and all 0 is recoded.

The lead-in zone and the lead-out zone are composed of a large number of zones as illustrated in FIG. 4. Among the zones, data indicating a recording state is only of an inner disc identification zone and an outer disc identification zone, and CD Zone (PFI). In the CD zone, data is not recorded in a case of virgin medium where data is not recorded yet, and when a format processing is performed, the thus obtained PFI information is copied from the ADIP to be stored.

In the inner disc identification zone and the outer disc identification zone, FDCB (Formatting Disc Control Blocks) information, and WDCB (Write inhibit Disc Control Blocks) information are recorded in a case where the optical disc is DVD+RW.

The FDCB information and the WDCB information hold the recording state of the respective optical discs. Among these pieces of information, on the basis of the LWA (Last Written Address), Formatting Bitmap, and Data Zone Allocation recorded on the CD zone, the recording state of the optical disc is decided. Also, it is eventually necessary to perform zero padding in the Inner Drive Test Zone (IDRT) which is a zone for executing OPC (Optimum Power Calibration) for optimizing the laser output.

In view of the above, according to the present embodiment, the following feature is obtained. That is, after the OPC is executed, data other than 0 (0x00 in hexadecimal notation) is recorded in the IDRT zone. After the data recording is completed, the zero padding is performed in the IDRT zone, and thus it is possible to determine the recording state of the optical disc 50. Hereinafter, a recording method and a reproduction method according to an embodiment of the present invention will be described in detail.

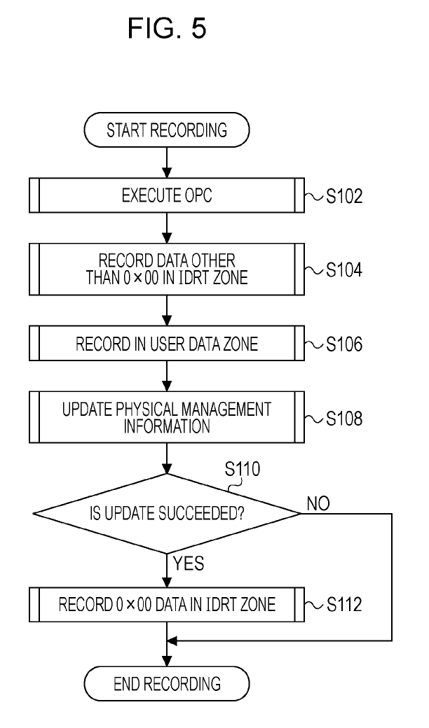

FIG. 5 is a flowchart for describing the recording method for the optical disc according to an embodiment of the present invention. Hereinafter, by using FIG. 5, the recording method according to the embodiment of the present invention will be described.

First, a recording demand is issued with respect to the optical disc 50, the CPU 21 demands the recording and reproduction control unit 41 to execute the OPC. The recording and reproduction control unit 41 having received the execution demand of the OPC executes the OPC to optimize the output of the laser light (step S102).

After the OPC is executed, the CPU 21 instructs the recording and reproduction control unit 41 to record data other than 0 at a position used for the OPC in the IDRT zone of the optical disc 50 (step S104). The IDRT zone has a length of 128 ECC (Error Correcting Code) blocks. When the OPC is executed, 1 ECC block is randomly selected from among ECC the blocks. According to the present embodiment, in step S104, data other than 0 (for example, 0x01) is recorded in the randomly selected zone.

After the data other than 0 is recorded at the position used for the OPC in the IDRT zone, subsequently, the CPU 21 instructs the recording and reproduction control unit 41 to perform recording of the data in the user data zone (Data Zone) of the optical disc 50 (step S106). Then, after the recording of the data in the user data zone of the optical disc 50 is completed, the CPU 21 performs the update of the physical management information of the optical disc 50 (step S108) and determines whether or not the physical management information is normally updated (step S110). Whether or not the physical management information is normally updated is determined on the basis of whether or not once the laser light reflected by the optical disc 50 is read by the signal processing unit 46, the recorded data is matched with the read data.

In a case where the physical management information is normally updated, the CPU 21 instructs the recording and reproduction control unit 41 to perform zero padding (recording by using 0x00) at the position used for the OCP in the IDRT zone where the data other than 0 is recorded in step S104 described above (step S112), and the recording processing is ended. However, in a case where the physical management information is not normally updated, the recording processing is directly ended without performing the zero padding.

Therefore, the optical disc 50 on which the physical management information is normally updated is subjected to the zero padding at the position used for the OCP in the IDRT zone. However, the optical disc 50 on which the physical management information is not normally updated is in a state where the zero padding is not performed at the position used for the OCP in the IDRT zone IDRT. Therefore, in a case where the optical disc on which the recording is performed in the above-mentioned manner is reproduced, by checking the recording state in the IDRT zone, it is possible to determine whether or not the medium on which the physical management information is normally updated.

In the above, the recording method for the optical disc according to the embodiment of the present invention has been described. Next, a reproduction method for the optical disc on which the recording is performed through the recording method according to the embodiment of the present invention will be described.

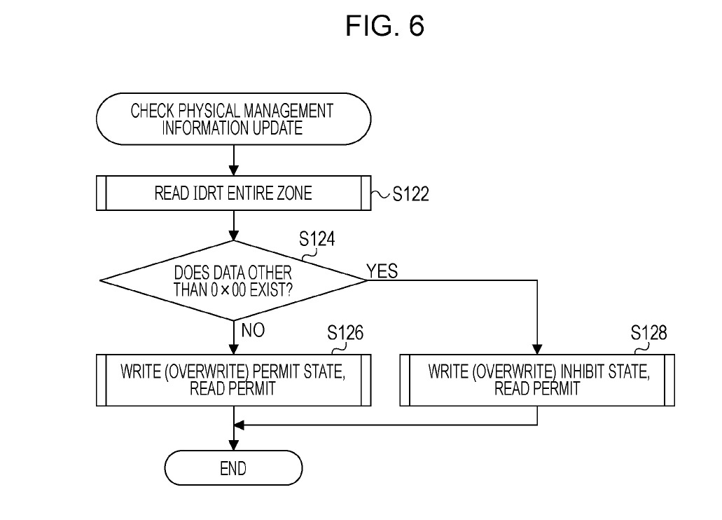

FIG. 6 is a flowchart for describing the reproduction method for the optical disc on which the recording is performed through the recording method according to the embodiment of the present invention. Hereinafter, by using FIG. 6, the reproduction method for the optical disc on which the recording is performed through the recording method according to the embodiment of the present invention will be described.

First, when the optical disc 50 is inserted into the disc camcorder 1, the CPU 21 instructs the recording and reproduction control unit 41 to read all zones in the IDRT zone of the optical disc 50 (step S122). Then, the recording and reproduction control unit 41 determines whether or not data other than 0 (0x00) exists in the data in the read IDRT zone (step S124).

As a result of the determination in step S124 described above, when the data other than 0 (0x00) does not exist in the data in the IDRT zone, the recording and reproduction control unit 41 determines that it is possible to perform write or overwrite on the optical disc 50 (step S126). On the other hand, as a result of the determination in step S124 described above, when the data other than 0 (0x00) exists in the data in the IDRT zone, the optical disc is determined to be a medium on which update of the physical management information is failed. Then, the recording and reproduction control unit 41 determines that the write or overwrite on the optical disc 50 is not allowed (step S128). Also, in either case, the read of data from the optical disc is permitted.

In the above, the reproduction method for the optical disc on which the recording is performed through the recording method according to the embodiment of the present invention has been described.

As described above, when the optical disc 50 is inserted into the disc camcorder 1, by checking the data in the IDRT zone of the optical disc 50, it is possible to determine whether or not the optical disc 50 is the medium on which the update of the physical management information is succeeded.

When the optical disc is the medium on which the update of the physical management information is failed, if the data recording is performed as it is, the data recorded immediately before on the optical disc 50 may be damaged in some cases. Therefore, the write or overwrite is not allowed on such a medium. As the write or overwrite is not allowed, the data recorded immediately before is protected, and such data can be reproduced by using various recovery tools.

It should be noted that the above-mentioned recording processing and reproduction processing may also be performed as the CPU 21 sequentially reads out the computer programs recorded on the ROM 23. As the CPU 21 executes the computer programs, the above-mentioned recording processing and reproduction processing can be executed.

In the above, the preferred embodiments of the present invention have been described with reference to the accompanying drawings, but of course the present invention is not limited to the above-mentioned examples. It should be understood by those skilled in the art that various modifications, combinations, sub-combinations, and alterations may occur depending on design requirements and other factors insofar as they are within the scope of the appended claims or the equivalents thereof, and it should be naturally understood that such various modifications, combinations, sub-combinations, and alterations are within the technical extent of the present invention.

For example, according to the above-mentioned embodiments, the disc camcorder 1 which performs the recording on the optical disc and the reproduction from the optical disc has been described as an example of the recording and reproduction apparatus of the present invention, the present invention is not limited to the above-mentioned example. The present invention can naturally also be applied to a recording apparatus which only performs the recording on the optical disc and a reproduction apparatus which only performs the reproduction from the optical disc.

What is claimed is:

1. A recording apparatus for recording information on a recording medium on which rewrite is permitted by using an optical element, the recording apparatus comprising:
an information recording unit adapted to record overwrite inhibit information indicating that overwrite on the recording medium is inhibited, in a predetermined zone before start of recording on the recording medium; and
a recording determination unit adapted to determine whether or not the recording on the recording medium is succeeded,
wherein the information recording unit performs the recording by filling the predetermined zone with overwrite permit information indicating that overwrite on the recording medium is permitted in a case where the recording determination unit determines that the recording on the recording medium is succeeded.

2. The recording apparatus according to claim 1, wherein
the predetermined zone is an IDRT (Inner Drive Test Zone) zone, and
the overwrite inhibit information and the overwrite permit information are recorded in an OPC (Optimum Power Calibration) execution area in the IDRT zone.

3. The recording apparatus according to claim 1, wherein
the overwrite inhibit information is a value other than 0, and
the overwrite permit information is 0.

4. The recording apparatus according to claim 1, wherein the recording medium is one of DVD+RW and Blu-ray disc.

5. A reproduction apparatus for reproducing by using an optical element, information recorded on a recording medium on which overwrite is permitted by using an optical element and in which information for determining whether or not rewrite is permitted is recorded in a predetermined zone, the reproduction apparatus comprising:
a reproduction unit adapted to reproduce the information recorded on the recording medium,
wherein the reproduction unit reads the information recorded in the predetermined zone of the recording medium to determine whether or not overwrite on the recording medium is permitted.

6. The reproduction apparatus according to claim 5, wherein the reproduction unit determines that overwrite on the recording medium is permitted when 0 is recorded in the predetermined zone, and determines that overwrite on the recording medium is inhibited when a value other than 0 is recorded in the predetermined zone.

7. The reproduction apparatus according to claim 5, wherein the recording medium is one of DVD+RW and Blu-ray disc.

8. A recording and reproduction apparatus for recording information on a recording medium on which rewrite is enabled by using an optical element and reproducing the recorded information by using an optical element, the recording and reproduction apparatus comprising:
an information recording unit adapted to record overwrite inhibit information indicating that overwrite on the recording medium is inhibited, in a predetermined zone before start of recording on the recording medium; and
a recording determination unit adapted to determine whether or not the recording on the recording medium is succeeded; and
a reproduction unit adapted to reproduce the information recorded on the recording medium, wherein
the information recording unit records so as to fill the predetermined zone with overwrite permit information indicating that overwrite on the recording medium is permitted in a case where the recording determination unit determines that the recording on the recording medium is succeeded, and
the reproduction unit reads the predetermined zone to determine whether or not overwrite on the recording medium is permitted.

9. The reproduction apparatus according to claim 8, wherein the reproduction unit determines that overwrite on the recording medium is permitted when 0 is recorded in the predetermined zone, and determines that overwrite on the recording medium is inhibited when a value other than 0 is recorded in the predetermined zone.

10. The reproduction apparatus according to claim 8, wherein
the predetermined zone is an IDRT (Inner Drive Test Zone) zone, and
the overwrite inhibit information and the overwrite permit information are recorded in an OPC (Optimum Power Calibration) execution area in the IDRT zone.

11. The reproduction apparatus according to claim 8, wherein
the overwrite inhibit information is a value other than 0, and
the overwrite permit information is 0.

12. The reproduction apparatus according to claim 8, wherein the recording medium is one of DVD+RW and Blu-ray disc.

13. A recording method for recording information on a recording medium on which rewrite can be performed by using an optical element, the recording method comprising the steps of:
recording overwrite inhibit information indicating that overwrite on the recording medium is inhibited, in a predetermined zone before start of recording on the recording medium;
determining whether or not the recording on the recording medium is succeeded; and
recording so as to fill the predetermined zone with overwrite permit information indicating that overwrite on the recording medium is permitted in a case where it is determined that the recording on the recording medium is succeeded.

14. A reproduction method for reproducing by using an optical element, information recorded on a recording medium on which overwrite is enabled by using an optical element and in which information for determining whether or not rewrite is permitted is recorded in a predetermined zone, the reproduction method comprising the step of:
reproducing the information recorded on the recording medium,
wherein the reproducing step includes reading the information recorded in the predetermined zone of the recording medium to determine whether or not overwrite on the recording medium is permitted.
